(19) United States
(12) Patent Application Publication
(10) Pub. No.: US 2007/0260771 A1
(43) Pub. Date: Nov. 8, 2007

(54) Method of Reducing Clock Differential in a Data Processing System

(76) Inventors: Cheng-Hao Lee, Taipei County (TW); Jui-Lun Chang, Hua-Lien Hsien (TW)

Correspondence Address: NORTH AMERICA INTELLECTUAL PROPERTY CORPORATION, P.O. BOX 506, MERRIFIELD, VA, 22116, US

(21) Appl. No.: 11/279,112

(22) Filed: Apr. 10, 2006

(51) Int. Cl. G06F 3/00

(52) U.S. Cl. 710/29

(57) ABSTRACT

A method of preventing buffer underrun and buffer overrun errors in a data processing system is disclosed. The method includes providing a reference frequency for the data processing system, storing data samples to be processed in a first in, first out (FIFO) register, detecting a level of the FIFO register for indicating how many data samples are stored in the FIFO register, dividing the reference frequency by a divisor for producing a working frequency having a lower frequency than the reference frequency, wherein the divisor is not equal to zero and the divisor is adjusted according to the level of the FIFO register, and processing the data samples stored in the FIFO register using the working frequency.

### BACKGROUND OF THE INVENTION

1. Field of the Invention

The present invention relates to preventing buffer underrun and buffer overrun errors in a data processing system.

2. Description of the Prior Art

For synchronized data transmission systems in which a transmitter receives a continuous analog signal is converted into digital signals and transmits the digital signals to a receiver, it is important that the operating frequencies of the transmitter and the receiver be as closely matched as possible. Even a tiny bit of difference in the operating frequencies of the transmitter and the receiver can cause operating errors or losses of data.

Please refer to FIG. 1. FIG. 1 is a functional block diagram of a data transmission system 10 according to the prior art. The data transmission system contains a transmitting side 20 and a receiving side 30. The transmitting side 20 comprises an analog-to-digital converter 29 for converting a continuous analog signal into digital samples and storing the digital samples in a transmission first in, first out (FIFO) register 28. For instance, the transmission FIFO register 28 can store pulse-code modulation (PCM) samples for transmission to the receiving side 30. A crystal 22 produces a working frequency of the transmitting side 20. The crystal 22 is rated at a specific frequency “f” plus a margin of error “a”, thereby having a frequency of f+a ppm. A baseband circuit 24 is used to modulate the PCM samples contained in the transmission FIFO register 28 and wirelessly transmit the modulated samples to the receiving side 30 through a radio frequency (RF) circuit 26.

The receiving side 30 receives the transmitted signals through an RF circuit 36, and a baseband circuit 34 demodulates the received signals and stores the demodulated signals in a reception FIFO 38. A digital-to-analog converter 39 converts the digital samples stored in the reception FIFO 38 into analog signals and accordingly outputs an analog signal. Another crystal 32 produces a working frequency of the receiving side 30. The crystal 32 is rated at a specific frequency “f” plus a margin of error “b”, thereby having a frequency of f+b ppm.

Unfortunately, the frequencies produced by the crystals 22 and 32 are always slightly different from each other. Although crystal 22 with a frequency of f+a ppm and crystal 32 with a frequency of f+b ppm are both rated at the same frequency f, both of the crystals 22 and 32 will be slightly off from these rated frequencies. If b>a, the frequency of the receiving side 30 will be faster than the frequency of the transmitting side 20. The end result of this is that over time the receiving side 30 will empty the reception FIFO 38 of samples faster than the transmitting side 20 can supply new samples, thus creating a buffer underrun situation. On the other hand, if b<a, the frequency of the receiving side 30 will be slower than the frequency of the transmitting side 20. This causes the receiving side 30 to be unable to process the samples stored in the reception FIFO 38 as quickly as the transmitting side 20 is able to supply new samples, thus creating a buffer overrun situation.

For situations in which the transmitting side 20 needs to be perfectly synchronized with the receiving side 30, any buffer underrun or buffer overrun problems will cause data to be lost or can cause interruptions in service. Therefore, it is highly important that the working frequencies of the transmitting side 20 and the receiving side 30 be matched as closely as possible.

### SUMMARY OF THE INVENTION

It is therefore an objective of the claimed invention to provide a method for reducing the clock differential in a data processing system in order to solve the above-mentioned problems.

According to an exemplary embodiment of the claimed invention, a method of preventing buffer underrun and buffer overrun errors in a data processing system is disclosed. The method includes providing a reference frequency for the data processing system, storing data samples to be processed in a first in, first out (FIFO) register, detecting a level of the FIFO register for indicating how many data samples are stored in the FIFO register, dividing the reference frequency by a divisor for producing a working frequency having a lower frequency than the reference frequency, wherein the divisor is not equal to zero and the divisor is adjusted according to the level of the FIFO register, and processing the data samples stored in the FIFO register using the working frequency.

According to another exemplary embodiment of the claimed invention, a data processing system for preventing buffer underrun and buffer overrun errors is disclosed. The data processing system includes a crystal for providing a reference frequency for the data processing system, a first in, first out (FIFO) register for storing data samples to be processed, a level register for detecting a level of the FIFO register and indicating how many data samples are stored in the FIFO register, a frequency divider for dividing the reference frequency by a divisor for producing a working frequency having a lower frequency than the reference frequency, wherein the divisor is not equal to zero and the divisor is adjusted according to the level of the FIFO register indicated by the level register, and a processor for processing the data samples stored in the FIFO register using the working frequency.

It is an advantage of the claimed invention that the divisor used by the frequency divider to produce the working frequency is adjusted according to the level of the FIFO register. In this way, both buffer underrun and buffer overrun errors can be avoided by keeping the FIFO at an optimum level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a data transmission system according to the prior art.

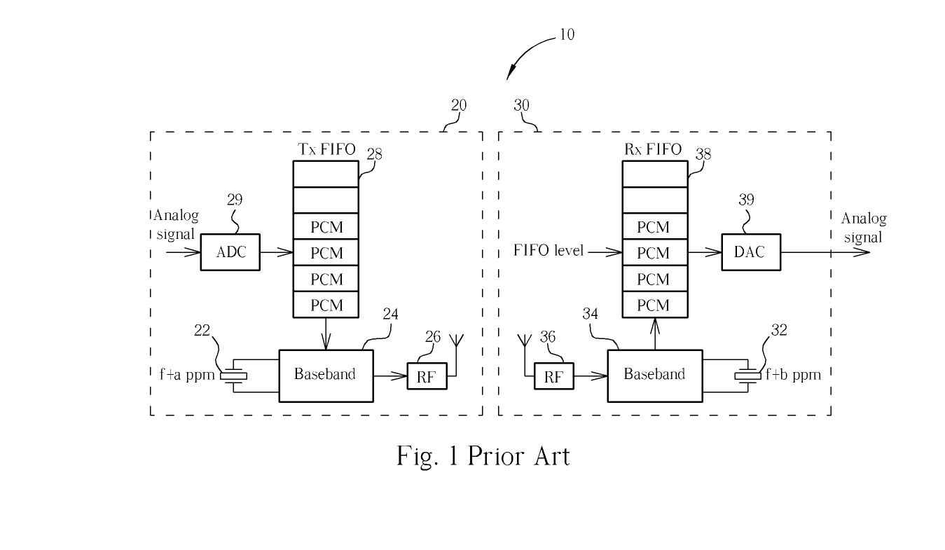

FIG. 2 is a functional block diagram of an improved data processing system according to the present invention.

FIG. 3 is a flowchart of the method of preventing buffer underrun and buffer overrun errors in a data processing system.

### DETAILED DESCRIPTION

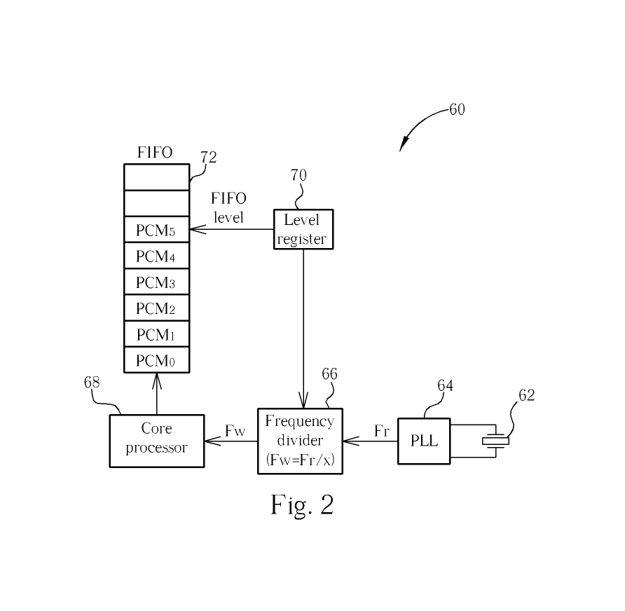

Please refer to FIG. 2. FIG. 2 is a functional block diagram of an improved data processing system 60 according to the present invention. The data processing system 60 is designed to correct synchronization problems that occurred in the prior art between a transmitting side and a receiving side of a data transmission system. The data processing system 60 can be implemented in a transmitting side or in a receiving side of a data transmission system, and works to prevent data underrun and data overrun problems from occurring. For simplicity, however, the data processing system 60 is preferably implemented in the receiving side of a data transmission system since the receiving side can be adjusted in response to the operation of the transmitting side.

A crystal 62 is used to provide an initial clock frequency, which is phase shifted by a phase-locked loop (PLL) 64 for providing a reference frequency Fr to a frequency divider 66. The frequency divider 66 divides the reference frequency Fr by a divisor x to produce a working frequency Fw. As an example, reference frequency Fr could be 12 MHz, the divisor could be 250, and the working frequency Fw could be 48 kHz. The divisor x is adjustable, as will be explained below, and the divisor x is preferably a whole number.

The working frequency Fw is provided to a core processor 68, which processes data samples stored in a FIFO register 72 by operating at the working frequency Fw. In order to determine how to adjust the value of the divisor x, a level register 70 is used to monitor the FIFO level and find out how many data samples are currently stored in the FIFO register 72.

If the level register 70 indicates that the number of data samples stored in the FIFO register 72 is greater than an upper threshold, then the frequency divider 66 decreases the value of the divisor x for producing a higher working frequency Fw. In this way, the core processor 68 can process the data samples stored in the FIFO register 72 more quickly and can accordingly decrease the number of data samples stored in the FIFO register 72. As a result, a buffer overrun situation is avoided.

Conversely, if the level register 70 indicates that the number of data samples stored in the FIFO register 72 is less than a lower threshold, then the frequency divider 66 increases the value of the divisor x for producing a lower working frequency Fw. In this way, the core processor 68 will process the data samples stored in the FIFO register 72 more slowly, which will gradually increase the number of data samples stored in the FIFO register 72. As a result, a buffer underrun situation is avoided.

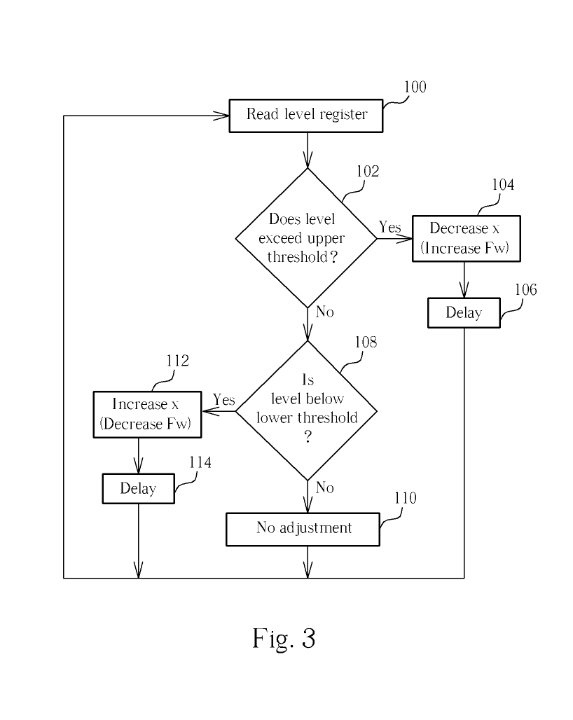

The present invention method is summarized in FIG. 3, which is a flowchart of the method of preventing buffer underrun and buffer overrun errors in a data processing system. Steps contained in the flowchart will be explained below.

Step 100: Read the value stored in the level register 70 to determine how many data samples are stored in the FIFO register 72.

Step 102: Determine if the value stored in the level register 70 is greater than an upper threshold. If so, go to step 104. Otherwise, go to step 108.

Step 104: Decrease the value of the divisor x, thereby increasing the working frequency Fw.

Step 106: Wait a predetermined delay period before going back to step 100.

Step 108: Determine if the value stored in the level register 70 is less than a lower threshold. If so, go to step 112. Otherwise, go to step 110.

Step 110: Since the number of data samples stored in the FIFO register 72 is neither too great nor too few, the divisor x and the working frequency Fw are not adjusted. Go back to step 100.

Step 112: Increase the value of the divisor x, thereby decreasing the working frequency Fw.

Step 114: Wait a predetermined delay period before going back to step 100.

As shown above, the present invention provides a simple way of preventing buffer underrun and buffer overrun situations from occurring in a data processing system. The present invention is useful for applications in which a continuous stream of data is received and the transmitting side of a data transmission system should be closely synchronized with the receiving side. One example of this would be for a wireless speaker system, where sound outputted by the speakers is continuously received and should be perfectly synchronized with the transmitted audio source.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of preventing buffer underrun and buffer overrun errors in a data processing system, the method comprising:
providing a reference frequency for the data processing system;
storing data samples to be processed in a first in, first out (FIFO) register;
detecting a level of the FIFO register for indicating how many data samples are stored in the FIFO register;
dividing the reference frequency by a divisor for producing a working frequency having a lower frequency than the reference frequency, wherein the divisor is not equal to zero and the divisor is adjusted according to the level of the FIFO register; and
processing the data samples stored in the FIFO register using the working frequency.

2. The method of claim 1, wherein adjusting the divisor according to the level of the FIFO register comprises increasing the divisor for lowering the working frequency when the level of the FIFO register is below a first threshold level.

3. The method of claim 2, wherein adjusting the divisor according to the level of the FIFO register further comprises decreasing the divisor for raising the working frequency when the level of the FIFO register is above a second threshold level.

4. The method of claim 1, wherein the divisor is a whole number.

5. A data processing system for preventing buffer underrun and buffer overrun errors, the data processing system comprising:
a crystal for providing a reference frequency for the data processing system;
a first in, first out (FIFO) register for storing data samples to be processed;
a level register for detecting a level of the FIFO register and indicating how many data samples are stored in the FIFO register;
a frequency divider for dividing the reference frequency by a divisor for producing a working frequency having a lower frequency than the reference frequency, wherein the divisor is not equal to zero and the divisor is adjusted according to the level of the FIFO register indicated by the level register; and
a processor for processing the data samples stored in the FIFO register using the working frequency.

6. The data processing system 5, wherein the frequency divider increases the divisor for lowering the working frequency when the level of the FIFO register is below a first threshold level.

7. The data processing system 6, wherein the frequency divider decreases the divisor for raising the working frequency when the level of the FIFO register is above a second threshold level.

8. The data processing system 5, wherein the divisor is a whole number.

9. The data processing system 5, further comprising a phase-locked loop for phase shifting the reference signal provided to the frequency divider.
